(19) United States
(12) Patent Application Publication
(10) Pub. No.: US 2026/0200425 A1
(43) Pub. Date: Jul. 16, 2026

(54) VEHICLE CONTROL SYSTEM, VEHICLE CONTROL METHOD, AND NON-TRANSITORY COMPUTER-READABLE STORAGE MEDIUM

(71) Applicant: HONDA MOTOR CO., LTD., Tokyo (JP)

(72) Inventors: Keita AKIHO, Tokyo (JP); Koichi FUJIMAKI, Tokyo (JP); Takayuki MASUO, Tokyo (JP); Atsushi HIGANO, Tokyo (JP); Atsushi ISHIOKA, Tokyo (JP)

(21) Appl. No.: 19/380,371

(22) Filed: Nov. 5, 2025

(30) Foreign Application Priority Data
Jan. 10, 2025 (JP) 2025-004007

(51) Int. Cl. B60R 21/0132; G01P 3/487; G01S 13/931; B60R 21/01; B60R 21/013

(52) U.S. Cl. CPC B60R 21/0133; G01P 3/487; G01S 13/931; B60R 2021/01211; B60R 2021/01311; B60R 2021/01322

(57) ABSTRACT

A vehicle control system includes: an obstacle recognizer configured to recognize an obstacle around a vehicle based on a signal from a radar; a vehicle speed calculator configured to calculate a vehicle speed based on a plurality of wheel speeds detected by a plurality of wheel speed sensors provided on a plurality of wheels; and a safety device controller configured to control a safety device based on a position of the obstacle and the vehicle speed. The vehicle speed calculator is configured to select a wheel speed to be used for calculating the vehicle speed from among the plurality of wheel speeds based on a state of the vehicle.

### TECHNICAL FIELD

The present invention relates to a vehicle control system, a vehicle control method, and a non-transitory computer-readable storage medium.

### BACKGROUND ART

In recent years, efforts have been actively made to provide sustainable transport systems that take into account people in vulnerable situations among traffic participants. To achieve this, research and development on safety technologies has been conducted to further improve safety and convenience of traffic.

A control content of a safety device, such as an airbag, provided in a vehicle may be changed based on a speed of the vehicle. For example, JP2023-136469A discloses a vehicle control system that deploys an airbag when acceleration exceeds the deployment threshold. The vehicle control system predicts a possibility of a collision with an obstacle based on a vehicle speed and lowers the deployment threshold of the airbag based on the possibility of the collision. Accordingly, the airbag is deployed at a lower acceleration when the possibility of the collision is present.

However, if an error occurs in the vehicle speed, it becomes difficult to properly control the safety device. For example, when the vehicle speed is calculated based on a signal from a wheel speed sensor provided on the wheel, there is a problem that an error occurs in the vehicle speed due to slippage of the wheel. Further, when the wheel speed sensor is configured with a permanent magnet and a Hall element, the wheel speed sensor may output an incorrect value due to the influence of electromagnetic waves generated during charging.

### SUMMARY OF THE INVENTION

In view of the above background, an object of the present invention is to provide a vehicle control system, a vehicle control method, and a non-transitory computer-readable storage medium configured to activate a safety device based on an appropriate vehicle speed.

To achieve such an object, one aspect of the present invention provides a vehicle control system, including: an obstacle recognizer configured to recognize an obstacle around a vehicle based on a signal from a radar; a vehicle speed calculator configured to calculate a vehicle speed based on a plurality of wheel speeds detected by a plurality of wheel speed sensors provided on a plurality of wheels; and a safety device controller configured to control a safety device based on a position of the obstacle and the vehicle speed, and the vehicle speed calculator is configured to select a wheel speed to be used for calculating the vehicle speed from among the plurality of wheel speeds based on a state of the vehicle.

Another aspect of the present invention provides a vehicle control method executed by a computer, the method including: recognizing an obstacle around a vehicle based on a signal from a radar; calculating a vehicle speed based on a plurality of wheel speeds detected by a plurality of wheel speed sensors provided on a plurality of wheels; controlling a safety device based on a position of the obstacle and the vehicle speed; and selecting the wheel speed to be used for calculating the vehicle speed from among the plurality of wheel speeds based on a state of the vehicle.

Another aspect of the present invention provides a non-transitory computer-readable storage medium comprising a control program, wherein the control program, when executed by a computer, executes a vehicle control method, including: recognizing an obstacle around a vehicle based on a signal from a radar; calculating a vehicle speed based on a plurality of wheel speeds detected by a plurality of wheel speed sensors provided on a plurality of wheels; controlling a safety device based on a position of the obstacle and the vehicle speed; and selecting the wheel speed to be used for calculating the vehicle speed from among the plurality of wheel speeds based on a state of the vehicle.

According to the above aspects, it is possible to provide the vehicle control system, the vehicle control method, and the non-transitory computer-readable storage medium configured to activate the safety device based on the appropriate vehicle speed.

### BRIEF DESCRIPTION OF THE DRAWINGS

FIG. 1 is a block diagram of a vehicle control system according to an embodiment of the present invention;

FIG. 2 is an explanatory diagram of a vehicle according to the embodiment;

FIG. 3 is a flowchart showing a procedure for calculating a vehicle speed in a vehicle control method according to the embodiment;

FIG. 4 is a flowchart showing a procedure for setting a deployment threshold in the vehicle control method according to the embodiment; and

FIG. 5 is a flowchart showing a procedure for controlling a deployment of an airbag in the vehicle control method according to the embodiment.

### DETAILED DESCRIPTION OF THE INVENTION

In the following, embodiments of a vehicle control system, a vehicle control method, and a non-transitory computer-readable storage medium will be described with reference to the drawings.

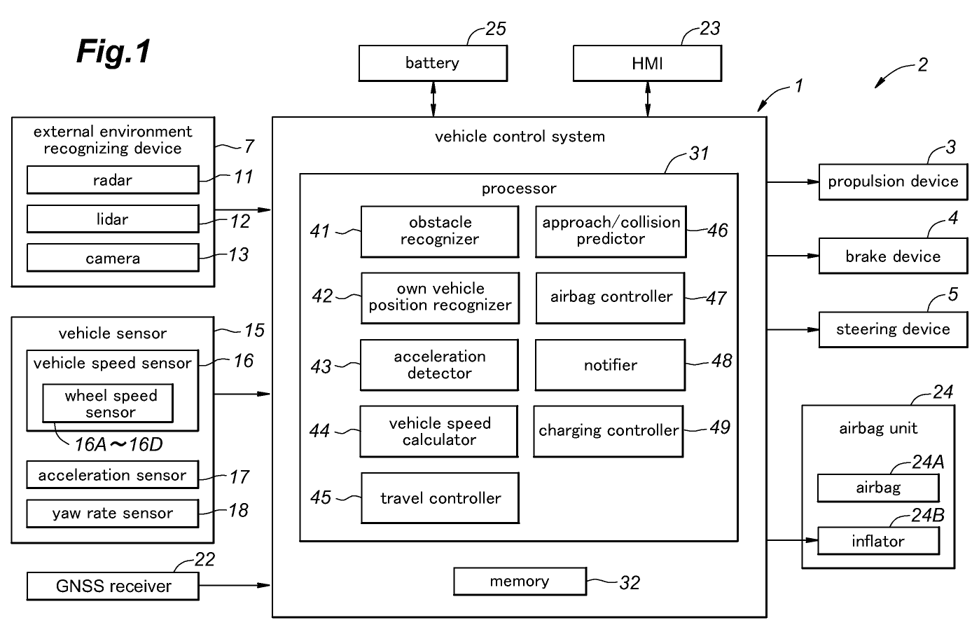

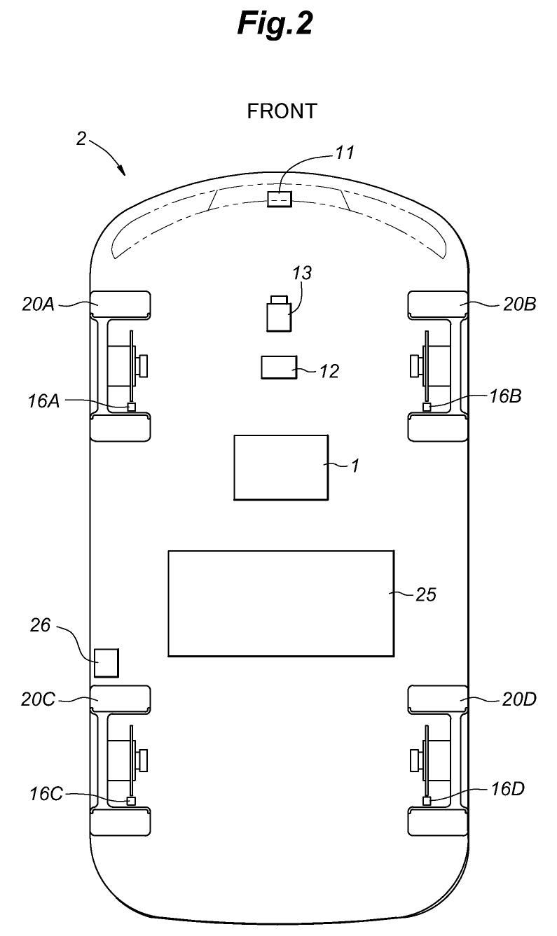

As shown in FIGS. 1 and 2, a vehicle control system 1 is installed in a vehicle 2. The vehicle 2 is a four-wheeled automobile. The vehicle 2 may be an autonomous driving vehicle or a vehicle with a driving assistance function.

The vehicle 2 includes a propulsion device 3, a brake device 4, and a steering device 5. The propulsion device 3 is a device that provides the driving force to the vehicle 2, and includes, for example, a power source and a transmission. The power source includes at least one of an internal combustion engine, such as a gasoline engine or a diesel engine, and an electric motor. The brake device 4 is a device that applies the braking force to the vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the vehicle control system 1.

The vehicle 2 includes an external environment recognizing device 7. The external environment recognizing device 7 is a device for detecting objects outside the vehicle and the like. The external environment recognizing device 7 is a sensor that captures electromagnetic waves and light from the surroundings of the vehicle 2 to detect the objects outside the vehicle. The external environment recognizing device 7 includes a radar 11, a lidar 12 (LIDAR), and a camera 13.

The radar 11 transmits radio waves around the vehicle 2 and detects the position and speed of the object by receiving the radio waves reflected by the object. The radar 11 is preferably a millimeter wave radar using millimeter waves as electromagnetic waves. It is preferable that a plurality of radars 11 be provided in the vehicle 2. The radar 11 includes at least a front radar that detects objects present in the area in front of the vehicle 2. The radar 11 may include a rear radar that detects the obstacle present in the area behind the vehicle 2. The radar 11 may include a plurality of corner radars that detect obstacles present in areas located in front-right, front-left, rear-right, and rear-left directions of the vehicle 2.

The front radar, which is one of the radars 11, is preferably installed in the center of the front end of the vehicle 2 in the lateral direction and transmits radio waves forward. The front radar may be arranged, for example, behind an emblem provided on the front end of the vehicle 2. The emblem is preferably made of a resin material that transmits radio waves. The front radar transmits radio waves at the prescribed angular range to the left and right with respect to the center line extending forward from the vehicle 2. For example, the angular range is preferably set to 20° or 15° to each of the left and right sides. For example, the front radar may transmit radio waves over a range of 30m to each of the left and right sides at a distance of 150m ahead of the vehicle 2. The front radar may transmit radio waves at the prescribed angular range upward and downward with respect to the center line.

The radar 11 transmits radio waves in a pulsed manner and measures the time until the reflected waves reflected by objects return. The radar 11 detects the intensity of the reflected waves and uses the directivity of the antenna to detect the angle at which the object is present. The radar 11 further measures the speed of the object using the Doppler effect based on the difference between the frequency of the reflected waves and the frequency of the transmitted waves. The radar 11 outputs the radar data including these measurements.

The lidar 12 irradiates light, such as infrared light, around the vehicle 2 and detects the position (distance and direction) of objects by capturing the reflected light. The lidar 12 may detect the obstacle present in the area in front of the vehicle 2.

The camera 13 captures images of the surroundings of the vehicle 2 and acquires images of the surroundings of the vehicle 2. The image of the surroundings of the vehicle 2 includes surrounding vehicles (surrounding moving objects), pedestrians, guardrails, curbs, walls, medians, the shape of the road, delimiting lines, road markings painted on the road, and the like that are present around the vehicle 2. The camera 13 may be, for example, a digital camera that uses a solid-state image sensor such as a CCD or CMOS. The camera 13 includes at least a front camera that captures the area in front of the vehicle 2. The camera 13 may include a rear camera that captures an image behind the vehicle 2 and a pair of side cameras that capture images on the left and right sides of the vehicle 2. The camera 13 may be, for example, a stereo camera.

The vehicle 2 includes a vehicle sensor 15. The vehicle sensors 15 include a vehicle speed sensor 16 that detects the speed of the vehicle 2, the acceleration sensor 17 that detects the acceleration, and a yaw rate sensor 18 that detects the angular velocity about a vertical axis. The vehicle sensor 15 may include an orientation sensor that detects the orientation of the vehicle 2.

The vehicle speed sensor 16 includes four-wheel speed sensors 16A to 16D provided on four wheels 20A to 20D. Each wheel speed sensor 16A to 16D detects the rotation speed of the corresponding wheel 20A to 20D. The wheel speed sensors 16A to 16D may be magnetic rotary encoders constituted by, for example, Hall elements and permanent magnets. In the present embodiment, the left and right front wheels are driving wheels 20A and 20B driven by the propulsion device 3, and the left and right rear wheels are driven wheels 20C and 20D. The four-wheel speed sensors 16A to 16D are provided on the left and right driving wheels 20A and 20B and the left and right driven wheels 20C and 20D, respectively.

The acceleration sensor 17 may detect the acceleration of the vehicle 2 in the front-and-rear direction and the acceleration in the up-and-down direction. The acceleration sensor 17 may also detect the acceleration of the vehicle 2 in the lateral direction.

The vehicle 2 includes a Global Navigation Satellite System (GNSS) receiver 22. The GNSS receiver 22 identifies the position (latitude and longitude) of the vehicle 2 based on signals received from artificial satellites (positioning satellites).

The vehicle 2 includes a Human Machine Interface (HMI) 23. The HMI 23 notifies the occupant of various information by display and sound and also accepts input operations by the occupant. The HMI 23 may include, for example, a touch panel display and a speaker.

The vehicle 2 is provided with an airbag unit 24 to protect the occupant in the event of a collision of the vehicle 2. The airbag unit 24 includes an airbag 24A and an inflator 24B that inflates the airbag 24A. The inflator 24B receives an electrical signal from the vehicle control system 1 and generates the inflation gas to inflate the airbag 24A. The airbag unit 24 may be provided in the steering wheel, an instrument panel, the front pillar, the middle pillar, the rear pillar of the vehicle 2, the side portion of a seat back, and the like. The airbag 24A is a type of the safety device.

The vehicle 2 is provided with a battery 25. The battery 25 supplies power to the propulsion device 3. The battery 25 can be connected to an external power source via a charging port 26 provided in the vehicle 2. The battery 25 receives power from the external power source and is charged.

The vehicle control system 1 is a computer including a processor 31 and a memory 32 communicatively connected to the processor 31. The processor 31 may include at least one of the following cores: a central processing unit (CPU), a graphics processing unit (GPU), and a reduced instruction set computer (RISC). The memory 32 stores the control program executed by the processor 31 and various data. The memory 32 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage, or an optical disk storage. At least a portion of the vehicle control system 1 may be realized by hardware such as a large scale integration (LSI), an application specific integrated circuit (ASIC), or a field-programmable gate array (FPGA), or may be realized by a combination of software and hardware. The vehicle control system 1 may be composed of a single piece of hardware or may be composed of plural pieces of hardware capable of communicating with each other. A portion of the vehicle control system 1 may be composed of an external server provided outside the vehicle 2.

The processor 31 realizes various applications by executing a program stored in the memory 32. The program may be stored in a removable recordable medium such as a DVD or a CD-ROM, and installed in the memory 32 as the recordable medium is read by a reading device. The program may also be downloaded and installed in the memory 32 via a communication network such as the Internet.

The map information may be stored in the memory 32. The map information may be high-precision map information. The map information contains road information which may include types of roads such as expressways, toll roads, national highways, and prefectural roads, the number of lanes in each road, the center position of each lane (three-dimensional coordinate including a longitude, a latitude, and a height), shapes of the road markings such as road delimiting lines and lane boundaries, presence or absence of sidewalks, curbs, fences and the like, positions of intersections, positions of lane-merging points and lane-branching points, areas of emergency parking zones, and the width of each lane, and road signs on the roads. The map information may also contain traffic control information, address information (address, postal code), facility information, telephone number information, and the like.

By executing the programs stored in the memory 32, the processor 31 functions as an obstacle recognizer 41, an own vehicle position recognizer 42, an acceleration detector 43, a vehicle speed calculator 44, a travel controller 45, an approach/collision predictor 46, an airbag controller 47, a notifier 48, and a charging controller 49. The memory 32 functions as a non-transitory computer-readable storage medium comprising the control program. The control program, when executed by the processor 31 of the vehicle control system 1, executes the vehicle control method.

The obstacle recognizer 41 recognizes the surrounding environment of the vehicle 2. The obstacle recognizer 41 recognizes the surrounding environment (external environment), including the obstacles located around the vehicle 2, the shapes of the roads, the presence or absence of sidewalks, road markings, and the like, based on the detection results of the external environment recognizing device 7. The obstacles include, for example, guardrails, utility poles, the surrounding vehicles, and people such as pedestrians. The obstacle recognizer 41 can acquire the position, speed, acceleration, and other states of the surrounding vehicles from the detection results of the external environment recognizing device 7.

In the present embodiment, the obstacle recognizer 41 recognizes the obstacle around the vehicle 2 based on the signal from the radar 11. The obstacle recognizer 41 acquires the position and speed of the obstacle based on the radar data. The position of the obstacle may be expressed by the distance between the vehicle 2 and the obstacle and the angle of the obstacle relative to the vehicle 2. The obstacle recognizer 41 may recognize a target whose reflected wave has an intensity equal to or greater than the prescribed value as the obstacle.

The own vehicle position recognizer 42 recognizes the position of the vehicle 2. The own vehicle position recognizer 42 may recognize the position of the vehicle 2 based on the GNSS signal received by the GNSS receiver 22.

The acceleration detector 43 detects the acceleration of the vehicle 2 based on a signal from the acceleration sensor 17. The acceleration detector 43 may include the longitudinal acceleration, the lateral acceleration, and the vertical acceleration of the vehicle 2.

The vehicle speed calculator 44 calculates the vehicle speed based on a plurality of wheel speeds detected by a plurality of wheel speed sensors 16A to 16D provided on a plurality of wheels 20A to 20D. The vehicle speed calculator 44 selects the wheel speed to be used for calculating the vehicle speed from among the plurality of wheel speeds based on the state of the vehicle 2. The state of the vehicle 2 includes, for example, the operating state of the anti-lock braking system (hereinafter referred to as ABS), the operating state of the traction control system (hereinafter referred to as TCS), a state where the yaw rate of the vehicle 2 is equal to or greater than the prescribed determination value, and the charging state. The operating state of the ABS and the operating state of the TCS are acquired from the travel controller 45.

The travel controller 45 executes ABS control and TCS control. In ABS control, the travel controller 45 acquires the wheel speed of each wheel 20A to 20D and reduces the braking force of the wheels 20A to 20D whose wheel speed is equal to or less than a prescribed lock threshold. Accordingly, the wheels 20A to 20D are prevented from locking. The travel controller 45 may execute ABS control only on the driving wheels 20A and 20B.

In TCS control, the travel controller 45 acquires the wheel speed of each wheel 20A to 20D, acquires the difference between the maximum and minimum values of each wheel speed, and reduces the driving force of the propulsion device 3 when the difference is equal to or more than a prescribed slip threshold. Accordingly, the driving wheels 20A and 20B are prevented from spinning.

The vehicle speed calculator 44 determines whether the ABS is operating and whether the TCS is operating based on the signal from the travel controller 45. When the ABS is operating, the vehicle speed calculator 44 sets the vehicle speed to the average value of the two highest wheel speeds among the four-wheel speeds. When the TCS is operating, the vehicle speed calculator 44 sets the vehicle speed to the average value of the wheel speeds of the two driven wheels 20C and 20D, or the average value of the two lowest wheel speeds.

When the yaw rate of the vehicle 2 is equal to or greater than the prescribed determination value, the vehicle speed calculator 44 sets the vehicle speed to the average value of the four-wheel speeds. When the yaw rate is equal to or greater than the determination value, it is estimated that the vehicle 2 is traveling on a curve. In this case, a difference in rotational speed is considered to occur between the right-side wheels 20A to 20D and the left-side wheels 20A to 20D.

The approach/collision predictor 46 determines a possibility of a collision between the obstacle and the vehicle 2. The approach/collision predictor 46 determines that the possibility of the collision between the obstacle and the vehicle 2 is present when a time to collision (TTC) between the obstacle and the vehicle 2 is equal to or less than a collision threshold. The approach/collision predictor 46 may determine the possibility of the collision for the obstacles, among the obstacles detected by the obstacle recognizer 41, whose distance from the vehicle 2 is within the prescribed value. The TTC may be calculated by dividing the distance between the obstacle and the vehicle 2 by the relative speed between the obstacle and the vehicle 2.

Further, the approach/collision predictor 46 determines an approach of the obstacle to the vehicle 2. The approach/collision predictor 46 may determine that the obstacle is approaching the vehicle 2 based on the distance between the obstacle and the vehicle 2.

The airbag controller 47 deploys the airbag 24A provided in the vehicle 2 when the acceleration is equal to or greater than the deployment threshold. The airbag controller 47 transmits the electrical signal to the inflator 24B of the airbag unit 24 when the acceleration is equal to or more than the deployment threshold. The inflator 24B receives the electrical signal from the airbag controller 47 and generates inflation gas to inflate the airbag 24A. The acceleration may be the longitudinal acceleration, the lateral acceleration, or the vertical acceleration of the vehicle 2.

The airbag controller 47 changes the deployment threshold based on the TTC between the obstacle and the vehicle 2. More specifically, when the approach/collision predictor 46 determines that the possibility of the collision between the obstacle and the vehicle 2 is present based on the TTC, the airbag controller 47 lowers the deployment threshold. By lowering the deployment threshold, the acceleration reaches or exceeds the deployment threshold at a lower acceleration, so that the airbag 24A is deployed earlier. The airbag controller 47, as a safety device controller, controls the safety device based on the position of the obstacle and the vehicle speed.

The notifier 48 controls the HMI 23 to provide the notification when the obstacle is approaching the vehicle 2. The HMI 23 controlled by the notifier 48 may notify the occupant by an image or sound. The notification provided by the HMI 23 may be so-called blind spot information (BSI), which notifies the driver that other vehicles exist in a blind spot behind the vehicle. The BSI may be an image displayed on a side mirror or an image displayed on a display inside the vehicle. The HMI 23 that notifies the occupant of the presence of other vehicles can be considered a type of the safety device.

The charging controller 49 controls the charging of the battery 25 when the external power source is connected to the charging port 26. The charging controller 49 detects a SOC of the battery 25 and controls the power supplied from the external power source to the battery 25 based on the SOC.

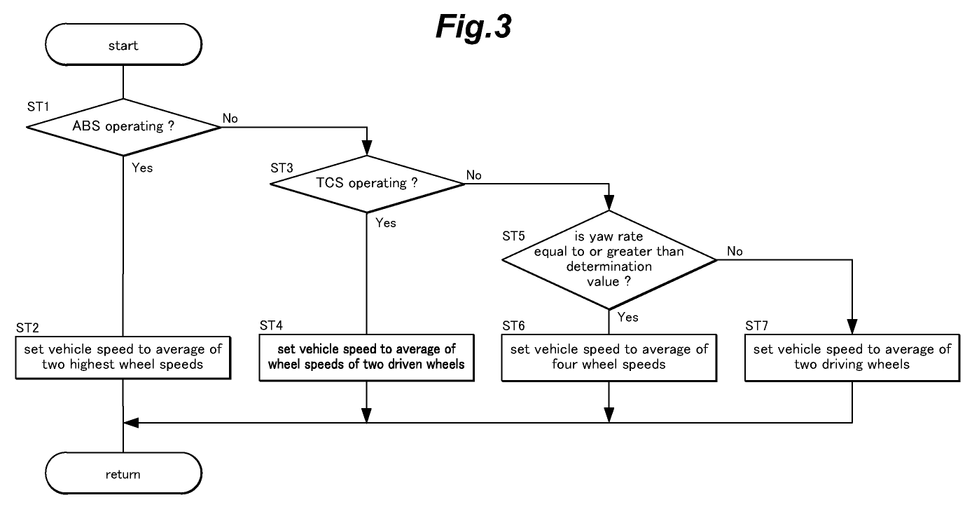

Next, the vehicle control method executed by the vehicle control system 1 will be described with reference to FIGS. 3 to 5. FIG. 3 is a flowchart showing the procedure for determining the vehicle speed. First, the vehicle control system 1 determines whether the ABS is operating (ST1). When the ABS is operating (ST1: Yes), the vehicle control system 1 sets the vehicle speed to the average value of the two highest wheel speeds among the four-wheel speeds (ST2). In another embodiment, in step ST2, the vehicle control system 1 may set the wheel speed to the average value of the two highest wheel speeds.

When the ABS is not operating (ST1: No), the vehicle control system 1 determines whether the TCS is operating (ST3). When the TCS is operating (ST3: Yes), the vehicle control system 1 sets the vehicle speed to the average value of the wheel speeds of the two driven wheels 20C and 20D (ST4). In another embodiment, in step ST4, the vehicle control system 1 may set the wheel speed to the average value of the two lowest wheel speeds.

When the TCS is not operating (ST3: No), the vehicle control system 1 determines whether the yaw rate is equal to or greater than the determination value (ST5). When the yaw rate is equal to or greater than the determination value (ST5: Yes), the vehicle control system 1 sets the vehicle speed to the average value of the four-wheel speeds (ST6).

When the yaw rate is less than the determination value (ST5: No), the vehicle control system 1 sets the vehicle speed to the average value of the two driving wheels 20A and 20B (ST7).

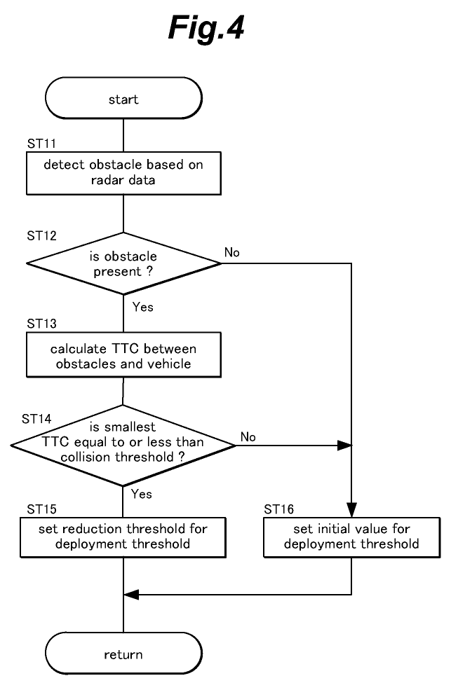

FIG. 4 is a flowchart showing a procedure for setting the deployment threshold. The vehicle control system 1 repeatedly executes the procedure for setting the deployment threshold at the prescribed time intervals. First, the vehicle control system 1 detects the obstacle based on the radar data acquired from the radar 11 (ST11). The number of detected obstacles may be zero, or one or more.

Next, the vehicle control system 1 determines whether the obstacle is present (ST12). When the obstacle is present (ST12: Yes), the vehicle control system 1 calculates the TTC between each of the obstacles and the vehicle 2 (ST13). The TTC may be calculated by dividing the distance between the obstacle and the vehicle 2 by the relative speed between the obstacle and the vehicle 2. The relative speed between the obstacle and the vehicle 2 may be calculated based on the speed of the vehicle 2 set based on the procedure of FIG. 3 and the speed of the obstacle acquired by the radar 11.

Next, the vehicle control system 1 determines whether the smallest value among the calculated TTCs is equal to or less than the collision threshold (ST14).

If the TTC is equal to or less than the collision threshold (ST14: Yes), the vehicle control system 1 sets a reduction threshold for the deployment threshold (ST15).

When the obstacle is not present (ST12: No), or when the TTC is greater than the collision threshold (ST14: No), the vehicle control system 1 sets an initial value for the deployment threshold (ST16).

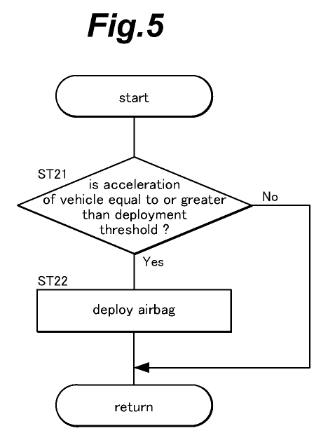

FIG. 5 is a flowchart showing a procedure for controlling the deployment of the airbag 24A. The vehicle control system 1 repeats the procedure for controlling the deployment of the airbag 24A in FIG. 5 at the prescribed time intervals. The vehicle control system 1 determines whether the acceleration of the vehicle 2 acquired by the acceleration sensor 17 is equal to or greater than the deployment threshold (ST21). The acceleration of the vehicle 2 may be the longitudinal acceleration, the lateral acceleration, or the vertical acceleration. The deployment threshold is set based on the procedure for setting the deployment threshold of FIG. 3.

When the acceleration of the vehicle 2 is equal to or greater than the deployment threshold (ST21: Yes), the vehicle control system 1 deploys the airbag 24A (ST22). More specifically, the vehicle control system 1 outputs the electrical signal to the inflator 24B of the airbag unit 24, causing the inflator 24B to generate inflation gas.

When the acceleration of vehicle 2 is less than the deployment threshold (ST21: No), the process proceeds to return.

According to the above embodiment, the wheel speed to be used can be changed according to the state of the vehicle 2, so that an appropriate vehicle speed can be calculated. Accordingly, it is possible to provide the vehicle control system 1 that can activate the airbag 24A as the safety device based on the appropriate vehicle speed. In the vehicle control system 1, the deployment threshold of the airbag 24A is set based on the TTC, and the TTC is calculated based on the speed of the vehicle 2.

The speed of the vehicle 2 is also used to determine the speed of the obstacle, such as the surrounding vehicle detected by the radar 11, using the Doppler effect. Accordingly, it is important in controlling the vehicle 2 to calculate the vehicle speed of the vehicle 2 with high accuracy.

The present embodiment is not limited to the above configuration and can be widely modified and implemented. For example, when the vehicle 2 is being charged, the vehicle speed calculator 44 may set the vehicle speed to the average value of the three-wheel speeds whose deviation from the median of the four-wheel speeds is the smallest. The charging controller 49 may output a signal indicating that the battery is being charged to the vehicle speed calculator 44 when the charging controller 49 is executing the charging control of the battery 25. The vehicle speed calculator 44 may determine whether the vehicle 2 is being charged based on a signal from the charging controller 49. The wheel speed sensor 16C arranged close to the charging port 26 may output an erroneous value due to the influence of a magnetic field generated by the current supplied from the external power source. Accordingly, when the vehicle 2 is being charged, the vehicle speed can be calculated with high accuracy by setting the vehicle speed to the average value of the three-wheel speeds whose deviation from the median of the four-wheel speeds is the smallest.

The vehicle control system 1 may control the HMI 23 to provide the notification when the vehicle speed of the vehicle 2 is equal to or less than the stop determination value and the obstacle is approaching the vehicle 2. This prevents the occupant from inadvertently opening the door. In this case, the HMI 23 is a type of the safety device, and the vehicle control system 1 and the HMI 23 constitute an exit warning device. In this case, even when the battery 25 is in a charged state, the vehicle speed can be calculated with high accuracy, and the vehicle control system 1 can appropriately control the HMI to provide the notification.

In addition to the airbag 24A and HMI 23, the safety device may include other devices, such as the brake device 4. The vehicle control system 1 predicts the possibility of the collision between the vehicle 2 and the obstacle based on the vehicle speed of the vehicle 2, the speed of the obstacle, and the distance between the vehicle 2 and the obstacle, and when the possibility of the collision between the vehicle 2 and the obstacle is determined to be present, the vehicle control system 1 may activate the brake device 4 to decelerate the vehicle 2. That is, the vehicle control system 1 and the brake device 4 constitute a collision mitigation braking system (CMBS). The vehicle control system 1 may activate the brake device 4 to decelerate the vehicle 2 when the TTC between the vehicle 2 and the obstacle is equal to or less than a determination value.

The above embodiment may also be described as follows.

One embodiment provides a vehicle control system 1, including: an obstacle recognizer 41 configured to recognize an obstacle around a vehicle 2 based on a signal from a radar 11; a vehicle speed calculator 44 configured to calculate a vehicle speed based on a plurality of wheel speeds detected by a plurality of wheel speed sensors 16A to 16D provided on a plurality of wheels 20A to 20D; and a safety device controller configured to control a safety device (an airbag 24A) based on a position of the obstacle and the vehicle speed, and the vehicle speed calculator 44 is configured to select a wheel speed to be used for calculating the vehicle speed from among the plurality of wheel speeds based on a state of the vehicle 2.

According to this aspect, the wheel speed to be used can be changed according to the state of the vehicle 2, so that an appropriate vehicle speed can be calculated. Accordingly, it is possible to provide the vehicle control system 1 that can activate the safety device based on an appropriate vehicle speed.

In the above embodiment, preferably, the safety device is the airbag 24A, and the safety device controller is configured to deploy the airbag 24A when acceleration of the vehicle 2 is equal to or greater than a deployment threshold, and change the deployment threshold based on a time to collision between the obstacle and the vehicle 2.

According to this aspect, the deployment threshold of the airbag 24A is changed based on the TTC, and the TTC is set based on the vehicle speed. Accordingly, by calculating an appropriate vehicle speed, the airbag 24A as the safety device is appropriately controlled.

In the above embodiment, preferably, the vehicle speed calculator 44 sets the vehicle speed to an average value of the two highest wheel speeds when an anti-lock braking system is operating.

According to this aspect, even when the anti-lock braking system is operating, an appropriate vehicle speed is calculated.

In the above embodiment, preferably, the vehicle speed calculator 44 sets the vehicle speed to an average value of the wheel speeds of two driven wheels 20C and 20D, or an average value of the two lowest wheel speeds when a traction control system is operating.

According to this aspect, even when the traction control system is operating, the appropriate vehicle speed is calculated.

In the above embodiment, preferably, the vehicle speed calculator 44 sets the vehicle speed to an average value of the four-wheel speeds when a yaw rate of the vehicle 2 is equal to or greater than a prescribed determination value.

According to this aspect, even when the vehicle 2 is turning, an appropriate vehicle speed is calculated.

In the above embodiment, preferably, the vehicle speed calculator 44 sets the vehicle speed to an average value of the three-wheel speeds whose deviation from a median of the four-wheel speeds is smallest when the vehicle 2 is being charged.

According to this aspect, even when some of the wheel speed sensors 16A to 16D are subjected to electromagnetic waves due to charging, an appropriate vehicle speed is calculated.

Another embodiment provides a vehicle control method executed by a computer, the method including: recognizing an obstacle around a vehicle 2 based on a signal from a radar 11; calculating a vehicle speed based on a plurality of wheel speeds detected by a plurality of wheel speed sensors 16A to 16D provided on a plurality of wheels 20A to 20D; controlling a safety device (an airbag 24A) based on a position of the obstacle and the vehicle speed; and selecting the wheel speed to be used for calculating the vehicle speed from among the plurality of wheel speeds based on a state of the vehicle 2.

According to this aspect, the wheel speed to be used can be changed according to the state of the vehicle 2, so that an appropriate vehicle speed can be calculated. Accordingly, it is possible to provide the vehicle control method that can activate the safety device based on an appropriate vehicle speed.

Another embodiment provides a non-transitory computer-readable storage medium comprising a control program, wherein the control program, when executed by a computer, executes a vehicle control method, including: recognizing an obstacle around a vehicle 2 based on a signal from a radar 11; calculating a vehicle speed based on a plurality of wheel speeds detected by a plurality of wheel speed sensors 16A to 16D provided on a plurality of wheels 20A to 20D; controlling a safety device (an airbag 24A) based on a position of the obstacle and the vehicle speed; and selecting the wheel speed to be used for calculating the vehicle speed from among the plurality of wheel speeds based on a state of the vehicle 2.

According to this aspect, the wheel speed to be used can be changed according to the state of the vehicle 2, so that an appropriate vehicle speed can be calculated. Accordingly, it is possible to provide a storage medium for executing the vehicle control method that can activate the safety device based on an appropriate vehicle speed.

1. A vehicle control system, comprising:
an obstacle recognizer configured to recognize an obstacle around a vehicle based on a signal from a radar;
a vehicle speed calculator configured to calculate a vehicle speed based on a plurality of wheel speeds detected by a plurality of wheel speed sensors provided on a plurality of wheels; and
a safety device controller configured to control a safety device based on a position of the obstacle and the vehicle speed, wherein
the vehicle speed calculator is configured to select a wheel speed to be used for calculating the vehicle speed from among the plurality of wheel speeds based on a state of the vehicle.

2. The vehicle control system according to claim 1, wherein the safety device is an airbag, and
the safety device controller is configured to
deploy the airbag when acceleration of the vehicle is equal to or greater than a deployment threshold, and
change the deployment threshold based on a time to collision between the obstacle and the vehicle.

3. The vehicle control system according to claim 1, wherein the vehicle speed calculator sets the vehicle speed to an average value of the two highest wheel speeds when an anti-lock braking system is operating.

4. The vehicle control system according to claim 1, wherein the vehicle speed calculator sets the vehicle speed to an average value of the wheel speeds of two driven wheels, or an average value of the two lowest wheel speeds when a traction control system is operating.

5. The vehicle control system according to claim 1, wherein the vehicle speed calculator sets the vehicle speed to an average value of the four wheel speeds when a yaw rate of the vehicle is equal to or greater than a prescribed determination value.

6. The vehicle control system according to claim 1, wherein the vehicle speed calculator sets the vehicle speed to an average value of the three wheel speeds whose deviation from a median of the four wheel speeds is the smallest when the vehicle is being charged.

7. A vehicle control method executed by a computer, the method comprising:
recognizing an obstacle around a vehicle based on a signal from a radar;
calculating a vehicle speed based on a plurality of wheel speeds detected by a plurality of wheel speed sensors provided on a plurality of wheels;
controlling a safety device based on a position of the obstacle and the vehicle speed; and
selecting the wheel speed to be used for calculating the vehicle speed from among the plurality of wheel speeds based on a state of the vehicle.

8. A non-transitory computer-readable storage medium comprising a control program, wherein the control program, when executed by a computer, executes a vehicle control method, comprising:
recognizing an obstacle around a vehicle based on a signal from a radar;
calculating a vehicle speed based on a plurality of wheel speeds detected by a plurality of wheel speed sensors provided on a plurality of wheels;
controlling a safety device based on a position of the obstacle and the vehicle speed; and
selecting the wheel speed to be used for calculating the vehicle speed from among the plurality of wheel speeds based on a state of the vehicle.
